(19) United States
(12) Patent Application Publication
(10) Pub. No.: US 2006/0131830 A1
(43) Pub. Date: Jun. 22, 2006

(54) Apparatus for stabilizing a unicycle

(76) Inventor: Frederic P. Berg, Seattle, WA (US)

Correspondence Address: BAY AREA INTELLECTUAL PROPERTY GROUP, LLC, PO BOX 210459, SAN FRANCISCO, CA, 94121-0459, US

(21) Appl. No.: 11/018,627

(22) Filed: Dec. 20, 2004

(51) Int. Cl. B62K 1/00

(52) U.S. Cl. 280/205; 280/293

(57) ABSTRACT

A device for allowing a person to ride a unicycle is disclosed. The device easily attaches to a unicycle to allow a person to ride the unicycle. The device has two modes of operation; it can at least partially stabilize the unicycle in two degrees of rotation, yaw and pitch or it can stabilize the unicycle in only the pitch rotation.

### FIELD OF THE INVENTION

This invention relates to unicycles and, more specifically, to riding aids for unicycles.

### BACKGROUND OF THE INVENTION

Unicycles are human-propelled single-wheel cycles. Unicycles are inherently unstable, even when ridden on a flat surface, as they have three degrees of rotation about the planer surface. For example, with the wheel-to-plane contact point as the center of rotation, the unicycle has the three degrees of rotation: yaw, pitch, and roll. Where yaw rotation is the rotation on the top-view of a horizontal plane, pitch rotation is the rotation on the front-view of a vertical plane, and roll rotation is the rotation on the end-view of a vertical plane. Generally, a person proficient at riding a unicycle must instinctively adjust their center of mass position (i.e., center of gravity, c.g.) to stabilize the unicycle and maintain a balanced position. To properly ride the unicycle the rider must continually maintain a balanced position. Among other benefits, unicycles are known to have advantages over other multi-wheel cycles e.g., bicycles, tricycles, quad-cycles, because they are smaller and lighter which makes them easier to transport and store. Unicycles are easier to place in an automobile, bus, or other mode of transportation, and unicycles take less space for placing in home closets, under stairs, in outdoor sheds, or other limited space storage environments.

Moreover, a person who rides a unicycle often wants to attract others attention. Spectators are often astonished when they see a person riding a unicycle. For this reason, unicycles are also used in carnivals, circuses, and other entertainment shows.

Because a unicycle has three degrees of rotation from a riding surface, a beginning rider has great difficulty maintaining stability and riding a unicycle. The disadvantage associated with riding a unicycle has made it apparent that a stabilizing system is needed to allow a person to ride a unicycle, or as an aid in teaching a person to ride a unicycle.

Attempts have been made to create designs that operate with unicycles to make them easier to ride. Some known solutions provide the rider with a place to put their hands. However, this approach is not generally effective, as it does not remove any of the three rotations, roll, pitch, and yaw of a unicycle. Another aspect of some known approaches is to add a rearward stabilizer consisting of a support frame and wheel; however, this design is inadequate at least because it only removes one-half of the pitch rotation, and it is inflexible at least because it removes all of the yaw rotation without providing an option to allow the yaw rotation.

Other known attempts implement a bulky multi-support, auxiliary wheel unit that eliminates the pitch and roll rotations of a unicycle. Such approaches miss the mark, as it is unnecessary to eliminate the roll rotation, since anyone who can ride a bicycle can correct for roll. Such techniques sometimes further include a spring mounted seat that allows the rollers on the auxiliary wheel unit to contact the riding surface when the rider applies force to the pedals; although this eliminates the possibility of high centering the unicycle wheel; however, this feature is generally unnecessary for a short wheelbase system; moreover, they are also cumbersome. Spring mounted seat approaches also suffer from the problem that they remove energy from the rotational system with each rotation of the pedal, as part of the rider's energy goes into extending the spring to push the wheel to the riding surface. To make a useful system out of such approaches, it is often critical to properly determine non-obvious parameters of the auxiliary wheel unit, such as the optimum wheelbase, the type of rollers, or the caster angle.

Yet other conventional approaches add a rearward stabilizer with a support frame and wheel; however, such designs are generally inadequate as they only constrain one-half of the pitch rotation. Moreover, they are often inflexible at least because they remove all of the yaw rotation without providing an option to allow the yaw rotation.

In view of the foregoing, there is a need for improved techniques to stabilize unicycle riding. It would be desirable if the stabilized unicycle was relatively simple to use and manufacture, lightweight, and have a relatively low rolling resistance. It would be further desirable if the stabilized unicycle was relatively stable at high speeds while maintaining high maneuverability.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side perspective view of an embodiment of the present invention attached to a unicycle; and

FIG. 2 illustrates an exploded view of the embodiment shown in FIG. 1 and a unicycle.

Unless otherwise indicated illustrations in the figures are not necessarily drawn to scale.

### SUMMARY OF THE INVENTION

To achieve the forgoing and other objects and in accordance with the purpose of the invention, a variety of unicycle stabilization techniques are described.

The present invention provides many aspects that address problems associated with riding a unicycle. Some of attendant aspects of some embodiments of the present invention include:
a) substantially stabilizing a conventional unicycle;
b) an attachment is provided that can be readily added to and removed from a conventional unicycle and disassembled into its component sections for storage or for convenient transporting;
c) providing a teaching aid to help a beginning rider to learn to ride a unicycle;
d) providing the option of stabilizing the unicycle in one or two rotational degrees; that is, either only the pitch rotation, or both pitch and yaw rotations together;
e) providing stabilization over 180 degrees for the pitch and the yaw rotations;

The providing of a unicycle stabilizing system that requires minimal additional energy during operation. One embodiment of the present invention provides two support shafts that extend from the unicycle's seat tube such that they to not touch the unicycle wheel and reach in general proximity to the ground where support wheels are mounted thereon to constrain the pitch and/or yaw degrees of freedom the unicycle.

In other embodiments, an apparatus is for stabilizing a unicycle provided, which includes support shaft means for supporting the unicycle (e.g., two elongated tubes of certain length, or one continuous tube of twice that length). In embodiments having two support shafts, each is configured with a unicycle joining end and a wheel receiving end, whereby means are provided for joining (e.g, removable “quick release” locking clamps) the support shaft means to the unicycle, and for joining the wheel receiving end of the support shaft means to at least one wheel and joining the unicycle end at a location on the unicycle that is generally non-obstructive to the rider (e.g., the unicycle seat tube). In some embodiments that have a single long support shaft that arcs over the unicycle wheel to within a proximity of the ground, the support wheels are attached at each end of the support shaft, and the support shaft is mounted to the unicycle at a mid point of the support tube.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

Embodiments of the present invention are directed towards enabling a person to more easily ride a unicycle by providing the rider with additional stability by way of at least partially constraining up to two of the three degrees of unicycle rotation. In this way, the present invention may serve as a teaching aid to help a beginning unicycle rider more quickly learn to ride a unicycle. In particular, a preferred embodiment of the present invention provides the rider the option of stabilizing the unicycle in either the pitch rotation, or both pitch and yaw rotations together.

In a preferred embodiment of the present invention a frame, preferably made from lightweight material, is provided, which frame can be relatively easily attached and removed from a unicycle, and is comprised of a fore and an aft support wheel. The fore and aft support wheels of the preferred embodiment are generally coplanar with the unicycle wheel. Each support wheel contains a caster angle, which maintains high-speed stability. Moreover, the wheelbase between the unicycle and support wheel is designed to maintain maneuverability.

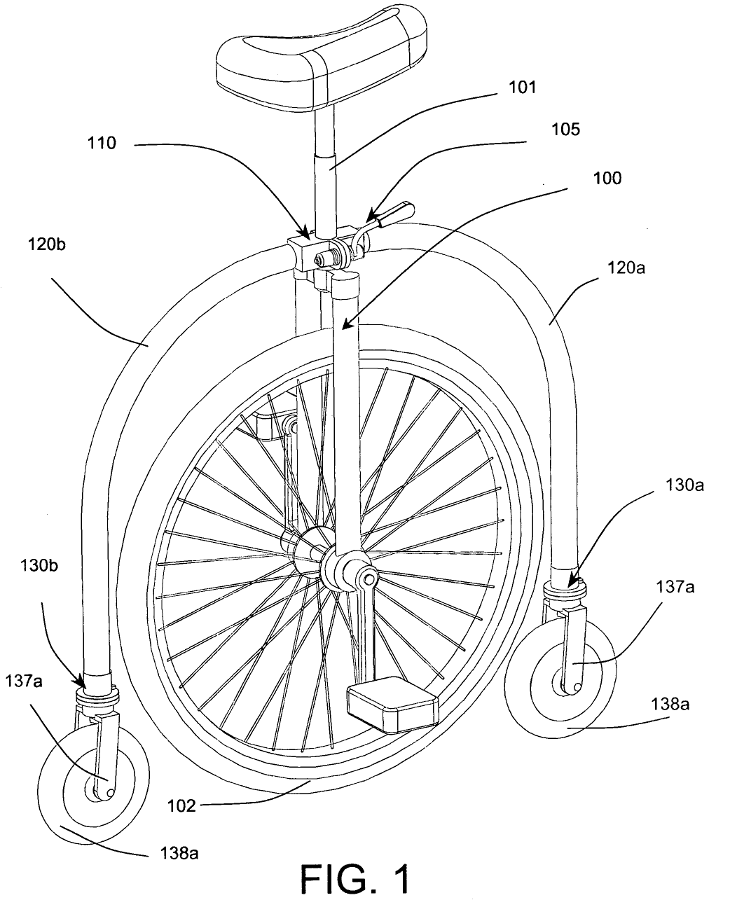

FIG. 1 illustrates a side perspective view of an exemplary instance of the preferred embodiment of the present invention attached to a conventional unicycle 100. The embodiment shown is generally comprised of a support tube clamp assembly 110, two support tubes 120a and 120b, and two support wheel assemblies 130a and 130b, which are rotababley joined to support wheels 138 a and b, respectively. It should be appreciated the term ‘tube’ used through out is meant to convey any suitable elongated supporting means (e.g., a shaft, etc.) for structurally supporting loads on each end. The support tube clamp assembly 110, attaches the two support tubes, 120a and 120b to the unicycle seat tube 101; it maintains generally coplanar orientation of the support tubes 120a and 120b to the unicycle wheel 102; the support tube clamp assembly also provides an adjustment for the vertical position of the support tubes 120a and 120b along the unicycle seat tube 101, thereby enabling adjustment of the offset distance between support wheels 138 and the ground. Although shown to follow the curvature of unicycle wheel 102, support tubes 120a and 120b may be shaped according to the needs of the particular application such that they preferably do not interfere with the unicycle's wheel rotation or the legs of the rider while peddling.

In the embodiment shown, support tube clamp assembly 110 is configured to be removable by way of a quick release locking system 105, which is well known to those skilled in the art. Alternative embodiments may configure support tube clamp assembly 110 to any suitable way that satisfies the needs of the particular application and the teachings of the present invention. Support tube 120a is attached to the support wheel assembly 130a and support tube 120b is attached to the support wheel assembly 130b. Support tubes 120a and 120b, are designed to be rigid and resist bending in the plane of the unicycle wheel 102; the support tubes are designed with a short wheelbase for high maneuverability. The term ‘wheelbase’ as used here is the distance between the point of contact that supports wheel 138a and support wheel 138b make with the riding surface (not shown). Each support wheel assembly 130a or 130b, contains a support wheel fork 137a and 137b respectively, which are designed with a low caster angle to maintain high-speed stability. Caster angle, as presently used, is the acute angle between an axis through the vertical portion of the support tube and the support wheel axel. In alternative embodiments, support wheels 138 may be configured with any known and suitable shape, size, surface texture, or composition as will be readily recognized and implemented by those skilled in the art. Moreover, although only one wheel is shown per side, yet other embodiments may implement more than one wheel on each side; for example, to achieve various performance and/or aesthetic benefits as will be apparent to those skilled in the art.

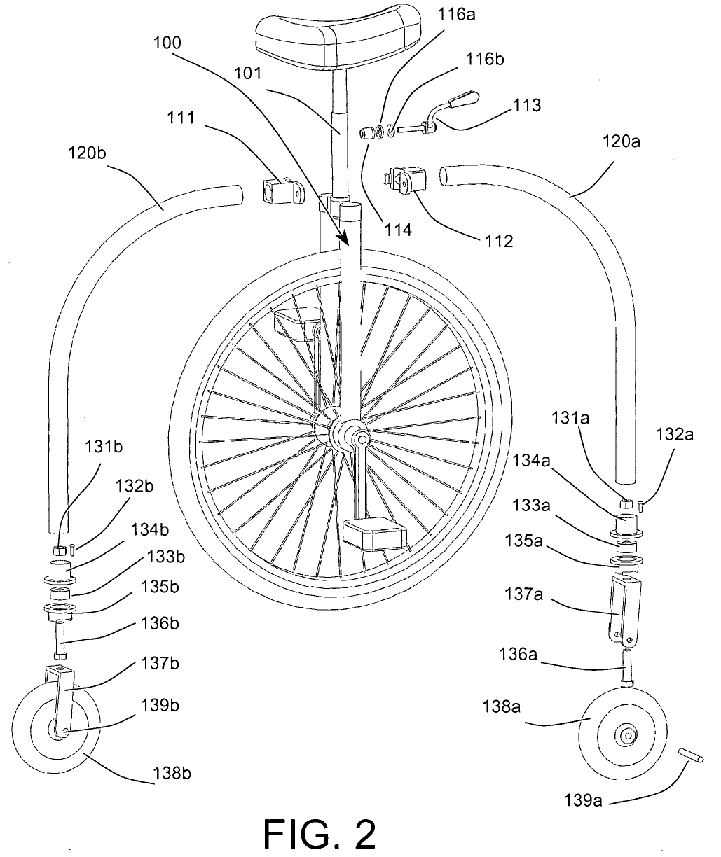

FIG. 2 illustrates an exploded view of the embodiment shown in FIG. 1. The support tube clamp assembly 110, is comprised of the female support tube clamp body 111 and the male support tube clamp body 112. The male and female support tube clamp bodies hook together on one edge to form a hinge; these two are then securely fastened to the unicycle seat tube 101 with the cam-clamping mechanism 105. The cam-clamping mechanism 105, which is comprised of the cam-clamping arm 113, the clamp nut 114, and the two clamp washers 116a and 116b, provides a fast, convenient, and adjustable means to securely fasten the female support tube clamp body 111 and the male support tube clamp body 112 to the unicycle seat tube 101. The clamping mechanism is a hand operated clamping system in the presently preferred embodiment though as will readily be perceived by those skilled in the art, any suitable hand operated clamping mechanism will serve to securely fasten the female support tube clamp body 111 and the male support tube clamp body 112 to the unicycle seat tube 101. The cam-clamping mechanism allows a person to first, finger tighten the arm's threaded portion to the clamp nut, then second, rotate the cam-clamping arm handle to complete the final tightening task. The cam-clamping mechanism makes use of the mechanical advantage of a cam to complete the tightening task by hand, without requiring the use of a wrench. Each support tube clamp bodies 111 and 112 is fixedly attached into their respective support tubes 120a and 120b according to known methods, including but not limited to, chemically-bonded, welded, and brazed. Given that the support wheel assemblies 130a and 130b in the present embodiment are identical, only one assembly need be described. The support wheel assembly 130a is comprised of a top thrust bearing housing 134a, bottom thrust bearing housing 135a, thrust bearing 133a, support wheel fork 137a, assembly bolt 136a, assembly nut and washer (not shown) 131a, support wheel 138a, caster locking pin 132a, and support wheel axel pin 139a. Assembly bolt 136a and assembly nut and washer 139a is an axel allowing the support wheel 138a, and support wheel fork 137a, to rotate 360 degrees in the plane parallel to the riding surface; the assembly bolt also fastens together the top thrust bearing housing 134a, thrust bearing 133a, bottom thrust bearing housing 135a, and the support wheel fork 137a. The top thrust bearing housing 134a is fixedly attached to the support tube 120a according to known methods, including but not limited to, chemically-bonded, welded, and brazed. The support wheel 138a is held into the support wheel fork 137a, with the support wheel axel pin 139a. The caster locking pin 132a, can be inserted into aligned holes in the top thrust bearing housing 134a, and the bottom bearing housing 135a to stop the support wheel and support wheel fork from rotating in the plane parallel to the riding surface. Hence, when the locking pin is removed, the present invention allows the unicycle to rotate in the yaw and the roll rotations. Those skilled in the art will appreciate that when riding the present embodiment in either forward or backward, both support wheel forks 137a and 137b rotate 180 degrees to make a negative caster angle. When the locking pin is inserted, the present embodiment enables the stabilized unicycle to rotate in only the roll rotation.

A multiplicity of alternate embodiments are contemplated and yet other useful embodiments and variations will readily be achieved by those skilled depending on the needs of the particular application. By way of example, and not limitation, in applications of the present invention directed to providing a “training wheel” functionality (similar to that of bicycles), one or both of support wheels 138a may be offset from the ground by a desired distance so that they only engage after a certain angle of unicycle tilt, which usually occurs upon the rider losing balance, thereby providing the rider the ability to partially constrain the pitch and/or yaw of the unicycle. There are many known ways to suitably adapt the foregoing embodiment to implement the training wheel embodiment. For example, one may shorten one or both of support tubes 120a and 120b to set the maximum offset from the ground. Other embodiments may provide versions of support wheel assembly 130a that are adjustable such that the ground clearance of the support wheels is fully adjustable with the set range.

Yet other embodiments of the present invention may be directed to applications where the rigid pitch and/or yaw constraints of the forgoing embodiments may, instead, be made more compliant, thereby provided more gradual corrective feedback to the rider. Although support wheel 138a may be comprised of compliant wheel materials to achieve less rigid engagement feedback, support tubes 120a and 120b may also be made of a somewhat compliant material (e.g., certain plastics, etc.) that sufficiently flexes as required by the needs of the application. Other means of modifying the foregoing constraining mechanisms to make them more compliant or adjustable will be recognized by those skilled in the art. By way of further example, and not limitation, support tube clamp assembly 110 may be configured to be compliantly joined to support tubes 120a and/or 120b, thereby achieving a more compliant unicycle pitch and/or yaw constraining system. Some applications may not require both sides of the support mechanism described in the foregoing embodiments, whereby only one support tube 120 would be implemented, thereby reducing the amount of constraint achieved as compared to the preferred embodiment.

In alternate embodiments of the present invention (not shown), support tubes 120a and 120b are replaced with one continuous tube having the same general shape as if both support tubes 120a and 120b where fixedly joined together at the unicycle mounting end of each tube. In such embodiments, the present stabilization apparatus would not be coplanar with the unicycle wheel, but, instead, would be offset from center by the width of the unicycle seat tube, given the side mounting thereon. Yet other continuous support tube embodiments (not shown) can made coplanar with the unicycle wheel be forming a mid-point bend in the continuous support tube, the bend being shaped to contour around the unicycle seat tube such that the rest of the continuous support tube is generally coplanar with the unicycle wheel. Those skilled in the art will readily configure suitable support tube clamps for clamping the continuous tube to the side of the unicycle seat tube.

Yet other alternative embodiments of the present invention (not shown) instead of removabley attaching the various support tube embodiments described above to the unicycle, non-removabley attach the support tube(s) to the unicycle by way of any known and suitable non-removable attachment means. By way of example, and not limitation, any of the forgoing embodiments may be welded, as original equipment, directly to the unicycle at location thereon such that during normal operation the present stabilization apparatus is substantially non-obstructive to the rider and the support shaft does not substantially touch the unicycle wheel.

Having fully described at least one embodiment of the present invention, other equivalent or alternative methods of stabilizing unicycles according to the present invention will be apparent to those skilled in the art. The invention has been described above by way of illustration, and the specific embodiments disclosed are not intended to limit the invention to the particular forms disclosed. For example, those skilled in the art will readily recognize without undue experimentation a multiplicity of alternative materials, components, and configurations of the foregoing embodiments that may better suit the needs of their particular application, wherein all such modifications of the present invention are contemplated as within the scope of the present invention. The invention is thus to cover all modifications, equivalents, and alternatives falling within the spirit and scope of the following claims.

What is claimed is:

1. An apparatus for stabilizing a unicycle, the apparatus comprising:
support shaft means for supporting the unicycle;
means for joining said support shaft means to the unicycle; and,
means for joining said support shaft means to at least one wheel, said support shaft means being joined to the at least one wheel at least one end by said wheel joining means, said support shaft means being further joined to the unicycle by said unicycle joining means at location on the unicycle that is generally non-obstructive to the rider.

2. An apparatus for stabilizing a unicycle, the apparatus comprising:
a first support shaft having a unicycle joining end and a wheel receiving end;
a second support shaft having a unicycle joining end and a wheel receiving end; said first and second support shafts being joined at their unicycle joining ends to the unicycle at location on the unicycle that is non-obstructive to the rider and such that both support shafts are generally coplanar with the unicycle wheel, said first and second support shafts being configured to not touch the unicycle wheel and reach in general proximity to the ground; and
at least one wheel rotatabley joined to the wheel receiving end of each support shaft.

3. The unicycle stabilizing apparatus of claim 2, wherein said first or second support shafts are at least partially compliant.

4. The unicycle stabilizing apparatus of claim 2, wherein the joining location of said first and second support shafts to the unicycle is located at a unicycle seat tube.

5. The unicycle stabilizing apparatus of claim 2, wherein said first or second support shafts are removabley joined to the unicycle.

6. The unicycle stabilizing apparatus of claim 2, wherein the rotateable joining of the at least one wheel to the wheel receiving end of each support shaft further permits directional rotation of the wheel about each respective support shaft.

7. The unicycle stabilizing apparatus of claim 2, wherein the rotateable joining of the at least one wheel to the wheel receiving end of said first or second support shafts further permits vertical adjustment of each respective wheel's height from the ground.

8. An apparatus for stabilizing a unicycle, the apparatus comprising:
a support shaft having a unicycle joining portion and two wheel receiving ends;
said support shaft being joined at the joining portion location thereof to the unicycle at location on the unicycle that is non-obstructive to the rider,
said support shaft being configured to not touch the unicycle wheel and reach in general proximity to the ground; and
at least one wheel rotatabley joined to each wheel receiving end of said support shaft.

9. The unicycle stabilizing apparatus of claim 8, wherein said support shaft is at least partially compliant.

10. The unicycle stabilizing apparatus of claim 2, wherein the joining location of said support shaft is located at midpoint thereof.

11. The unicycle stabilizing apparatus of claim 2, wherein the joining location of said joining portion to the unicycle is located at a unicycle seat tube.

12. The unicycle stabilizing apparatus of claim 8, wherein said support shaft is removabley joined to the unicycle.

13. The unicycle stabilizing apparatus of claim 8, wherein the rotateable joining of the at least one wheel to the wheel receiving end of said support shaft further permits directional rotation of the wheel about said support shaft.

14. The unicycle stabilizing apparatus of claim 8, wherein the rotateable joining of the at least one wheel to the wheel receiving end of said shaft further permits vertical adjustment of at least one wheel's height from the ground.

15. The unicycle stabilizing apparatus of claim 8, wherein the joining portion is shaped to generally contour around the seat tube of the unicycle such that the rest of the support tube is generally coplanar with the unicycle wheel when joined to the unicycle.
